(19) United States
(12) Patent Application Publication
(10) Pub. No.: US 2003/0124302 A1
(43) Pub. Date: Jul. 3, 2003

(54) Method and apparatus for making pile assemblies and products therefrom

(76) Inventors: Mark S. Edwards, Hockessin, DE (US); Robert M. Brown, Boothwyn, PA (US); William H. Sherman, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/266,656

(22) Filed: Oct. 8, 2002

Related U.S. Application Data
(60) Provisional application No. 60/336,210, filed on Oct. 29, 2001.

(51) Int. Cl. B32B 3/02; D04H 11/00

(52) U.S. Cl. 428/92; 428/97; 428/371

(57) ABSTRACT

An apparatus or method for forming a pile assembly without the use of additional materials as an adhesive or preformed core, and the products/articles made therefrom. The method and apparatus uses the beam or base member of the elongated pile sub-assemblies (e.g. tuftstrings or rooted tuftstrings) to form a continuous tubular core. This method and/or apparatus can be used to form articles such as brush rollers, interior panels for various modes of transportation, or a flooring article. The melt flow of the beam adjacent to one another along a mandrel surface form a continuous base material. In the case of a roller brush this base material forms a core from which the pile for roller brushes radially extend. Making a roller brush or other article in this manner eliminates the cores adhesives and fabric support material normally required for the pile yarn. Also a mandrel can be used to form a variety of geometric shapes for the cores of the present invention.

This application claims the benefit of U.S. Provisional Application No. 60/336,210, filed Oct. 29, 2001.

### FIELD OF THE INVENTION

The present invention relates to a method, apparatus and/or articles having a pile assembly formed entirely from elongated pile sub-assemblies. More particularly, the present invention relates to a method and apparatus for making a pile assembly without the use of additional materials such as an adhesive and a separate pre-formed support structure. Furthermore, the invention relates to articles or products from an elongated pile sub-assembly such as a roller brush, interior panels for various modes of transportation and flooring articles.

### BACKGROUND OF THE INVENTION

The following disclosures may be relevant to various aspects of the present invention and may be briefly summarized as follows:

It is known in the art to form paint rollers with preformed cores. For example, winding strips of pile material around a separate plastic or cardboard tube or, alternatively, wrapping bands of thermoplastic, then fusing them together to form a core and then attaching pile strips to the cores via adhesive or other means are known methods for forming paint rollers.

U.S. Pat. No. 5,397,414 to Garcia et al. discloses a paint roller made from a thermoplastic tubular core and strips of pile material upstanding from a fabric base. The fabric strips are bonded to the tubular core by heat bonding the fabric cover to the thermoplastic core using a thermoplastic adhesive.

U.S. Pat. No. 6,175,985 B1 to Chambers et al. discloses a paint roller that includes a core tube made from tuftstrings. At least one tuftstring is spirally wrapped around the core tube and adhesively or otherwise bound to the core tube. Alternatively, tuftstrings are attached to a backing material to form a pile strip, which subsequently is attached to a preformed core.

U.S. Pat. No. 5,470,629 to Mokhtar et al. describes making pile “tuftstrings” where each tuftstring is made by wrapping yarn around a mandrel on which a support strand is translated. As the support strand moves, it transports “wraps” of yarn to an ultrasonic welder which connects the wraps to the support strand. The bonded wraps are further transported to a slitter station which cuts the wraps and thereby forms the tuftstring. The tuftstring includes two rows of upstanding legs or tufts which are attached at their bases to the support strand. The yarn of Mokhtar et al. is a multifilament, crimped, bulky yarn that is made preferably of a thermoplastic polymer, such as nylon or polypropylene. The support strand is likewise preferably a thermoplastic polymer so that, when passed under the ultrasonic welder, the yarn and support strand melt to form a bond therebetween.

It is desirable to form or create articles having a pile surface without the use of a separately preformed tube or support sheet thus eliminating the need for costly additional materials such as adhesives and preformed support structure. In the prior art, the use of a pre-formed support structure requires at least two steps: a first step of forming or supplying the support structure and a second step of bonding the pile structure to the support structure. Eliminating the preformed support structure reduces the cost and increases the efficiency (e.g. eliminates a step) of creating articles such as a roller brush, interior panels for various modes of transportation and flooring articles. It is further desirable to provide a continuous process to eliminate losses due to splices of the pile strips.

### SUMMARY OF THE INVENTION

Briefly stated, and in accordance with one aspect of the present invention, there is provided a method to form a pile assembly comprising: guiding at least one elongated pile sub-assembly onto a mandrel having a surface, the at least one elongated pile sub-assembly comprising a base member with at least one tuft extending therefrom; wrapping said base member of the at least one elongated pile sub-assembly around the surface of the mandrel forming a plurality of abutting wraps of said base member about the mandrel surface and concurrently said base member having a surface between the abutting wraps directly contacting the mandrel surface; heating the abutting wraps of said base member to at least partially melt said base member of alternate wraps, the at least partial melt creating a bridge between the abutting beam wraps; cooling a melt bridge of the at least partial melt of the abutting wraps to form a fused joint between abutting beams of the abutting wraps and further forming a continuous tubular base from which the at least one tuft of the elongated pile sub-assembly extends outwardly therefrom; and cutting the continuous tubular base to form at least one pile covered segment.

Pursuant to another aspect of the present invention, there is provided an apparatus for making pile assemblies comprising a: means for guiding at least one elongated pile sub-assembly, having a base member and a tuft attached thereto, onto a mandrel having a surface; means for wrapping the base member of the at least one elongated pile sub-assembly around the mandrel surface to form a plurality of abutting base member wraps, the base member of each wrap has a surface that concurrently abuts the mandrel surface and other surfaces that abut adjacent wraps shoulder to shoulder; means for heating the base member wraps to at least partially melt the base member of alternating wraps; means for bridging a melt between abutting base member wraps; means for cooling a melt bridge of the abutting base member wraps to form a fused joint between abutting base members forming a continuous tubular base from which the tuft of the elongated pile sub-assembly extends outwardly therefrom; and means for cutting the continuous tubular base to form at least one pile covered segment.

Pursuant to another aspect of the present invention, there is provided an apparatus for making pile assemblies comprising a: means for guiding at least one elongated pile sub-assembly, having a base member and a tuft attached thereto, onto a mandrel; means for wrapping the base member of the at least one elongated pile sub-assembly around the mandrel surface; means for indexing each wrap forward to form a plurality of abutting base member wraps, such that each base member concurrently abuts the mandrel surface; means to extrude a polymer melt from within the mandrel to a circumferential discharge slot; means of forming a continuous tube of polymer melt underlying the indexing base member wraps; means for cooling the continuous tube of melt to form a fused connection between the base member wraps and to form a continuous solid tubular base from which the tuft of the elongated pile sub-assembly extends outwardly therefrom; and means for cutting the continuous tubular base to form at least one pile covered segment.

Pursuant to another aspect of the present invention, there is provided a pile assembly comprising at least one elongated pile sub-assembly wrapped in a helical manner about a mandrel, each of the helical wraps being joined along an abutted vertical surface of an adjacent wrap, forming a continuous base material.

### BRIEF DESCRIPTION OF THE DRAWINGS

The invention will be more fully understood from the following detailed description, taken in connection with the accompanying drawings, in which:

FIG. 1A is an elevational view of an apparatus of the present invention showing a mandrel with a heat zone and a lay-in ring;

FIG. 1B is a cross-sectional view of the elongated pile sub-assembly in FIG. 1A;

FIG. 2A is a topical view of the lay-in ring;

FIG. 2B is a perspective view of the lay-in ring;

FIG. 3 is a cross-sectional view of adjacent elongated pile sub-assembly wraps in abutting contact.

FIG. 4A is a view of the heat/melting of the inner radial section of the beam of the elongated pile sub-assemblies:

FIG. 4B is a view of the short segment fibers or roots trailing behind the elongated pile sub-assembly as the elongated pile sub-assembly translates along the mandrel surface;

FIG. 5 is an elevational view of an apparatus for the present invention showing an ultrasonic source as the heating element;

FIG. 6A is a topical view of the lay-in ring showing the ultrasonic horn;

FIG. 6B is a perspective view of the lay-in ring of an embodiment of the present invention;

FIG. 7A is a schematic view of an ultrasonic horn used in an embodiment of the present invention;

FIG. 7B is an end view of the ultrasonic horn tip; and

FIG. 8 is a schematic view of an interlocking beam embodiment.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

Definitions:

The following definitions are provided as reference in accordance with how they are used in the context of this specification and the accompanying claims.

1. Beam (e.g. base member): An elongated strip, strand, string, yarn, thread, wire or cord composed of one or more materials and having one or more separate structural components, each having its own defined and identifiable shape.

2. Denier: The mass in grams of 9000 meters of a fiber, filament, or yarn.

3. Elongated Pile Sub-Assembly: An elongated pile sub-assembly refers to any of the several pile sub-assemblies (e.g. tuftstrings or rooted tuftstrings) connected or bonded along a length of beam. The beam being substantially perpendicular to the length of the pile forming material such as a yarn.

4. Fiber: Textile raw material, generally characterized by flexibility, fineness and high ratio of length to thickness.

5. Filament: A fiber of indefinite length.

6. Filament Yarn: Normally continuous filament. A yarn composed of one or more filaments that run essentially the whole length of the yarn. Yarns of one or more filaments are usually referred to as ‘monofilament’ or ‘multifilament’, respectively.

7. Pile Assembly: An article having a pile surface. For example, a roller brush or flooring articles.

8. Tuft: The segment of yarn that projects from a point of attachment such as in a tuftstring or rooted tuftstring. The yarn segment can either be a cut or looped length.

9. Tuftstring: A beam segment having attached to it at least one segment of yarn consisting of one or more filaments each having a diameter such that the diameter is reported in units of denier rather than thousandths of an inch (mils). Tuftstrings have a variety of descriptive shapes such as Rooted Tuftstrings (as described in the present invention) or V-shaped (i.e. for monofilament bristle sub-assemblies) or U-shaped.

10. Rooted Tuftstring: A tuftstring that uses a portion of its non-bonded yarn fiber ends to attach it to other articles. The tuftstring has two ends separated from one another by the beam bonded perpendicularly to the yarn ends. One end forms the pile and the opposite forms the “root” and is used for attaching the tuftstring to an article or base material. The pile end is a longer bundle segment than the root end which is a shorter bundle segment.

11. Yarn: A product of substantial length and relatively small cross-section consisting of fibers and/or filaments with or without twist.

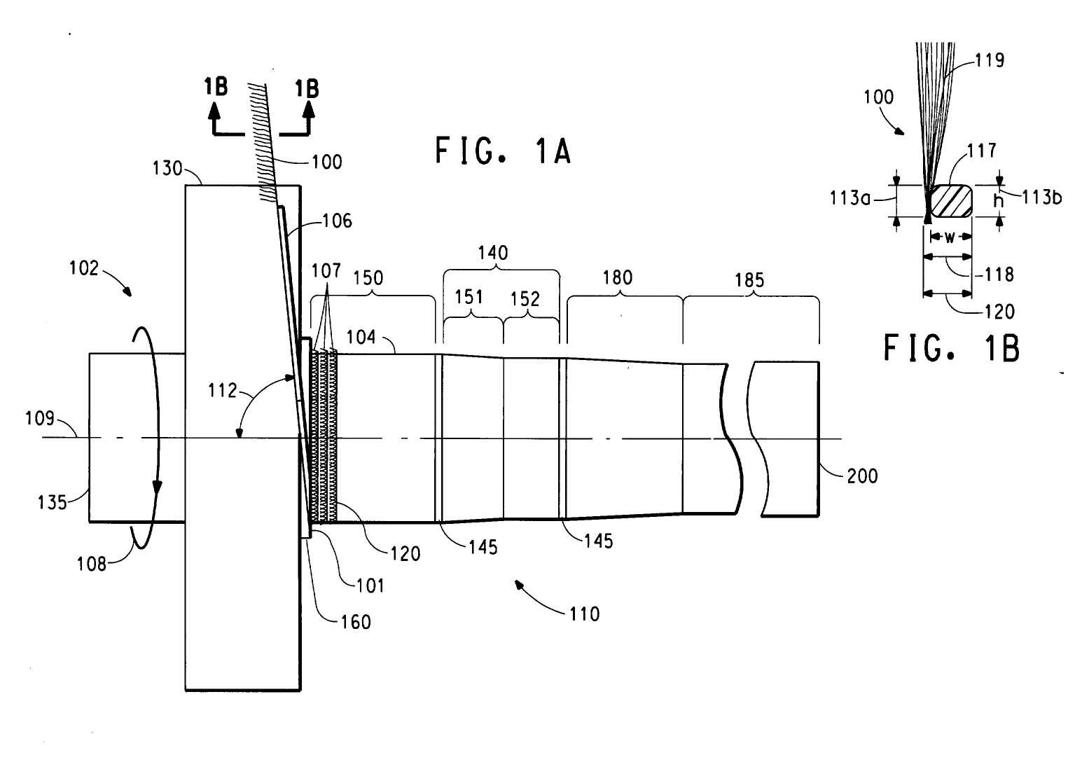

Reference is now made to the drawings for a detailed description of the present invention. The present invention is a method and apparatus of making a pile covered roller brush core or other support structures (such as a flooring article) from elongated pile sub-assemblies without the need for additional materials, such as pre-formed cores and adhesives. Reference is now made to FIG. 1A, which shows an elevational view of an apparatus 102 for the method of forming a pile assembly such as a roller brush or other pile articles. In this embodiment of the present invention, an elongated pile sub-assembly (e.g. plurality of tuftstrings) 100 is spirally wound onto a mandrel 110. The tuftstrings of the elongated pile sub-assembly 100 can be made in a variety of known methods and have a variety of descriptive shapes (including U-shaped, V-shaped, or rooted tuftstrings). The V and U shaped tuftstrings are well known in the art. (See U.S. Pat. Nos. 5,547,732, 6,269,514 and 6,096,151 for descriptions of these shapes.) The rooted tuftstring is described in co-pending and concurrently filed application DuPont Docket No. AD6827, (U.S. Provisional Patent Application No. 60/336,226). In the present invention, the elongated pile sub-assembly in the present invention for spiral winding on the mandrel preferably has “roots” (e.g. rooted tuftstring). This preference resulting from the secure anchor provided by the “roots” in comparison to other tuftstrings.

The method described herein describes the feeding of a single elongated pile sub-assembly to form a pile assembly article. However, a plurality of elongated pile sub-assemblies can be similarly fed for higher productivity or to provide a combination of tuft colors, tuft yarn compositions, tuft heights or other variables known to the art, or to introduce a spacer between the elongated pile sub-assemblies to reduce pile density of the pile assembly article. In the present invention, elongated pile sub-assemblies with rectangular beams are preferred, though other cross-sectional shapes can also be used successfully.

With continuing reference to FIG. 1A, the elongated pile sub-assembly 100 is continuously fed from a suitable feeding source under tension (not shown) through the guide slot 106 of the lay-in ring 130. The elongated pile sub-assembly 100 is positioned by the stationary lay-in ring 130 onto the rotating mandrel surface 104 such that the basal portion 120 of the elongated pile sub-assembly tuftstrings orient themselves against the surface 104 of the rotating mandrel 110 and thus, project the pile forming tufts radially outward from the mandrel surface. (Alternatively, the lay-in ring could rotate about a stationary mandrel.) The mandrel rotates in a direction shown by arrow 108 and is driven by a pulley and belt system, gear or other such means coupled to a suitable drive system (not shown). The width of the guide slot 106 provides sufficient clearance between the basal area 120 of the tuftstrings of the elongated pile sub-assembly and the walls of the guide slot 106 to minimize frictional drag and distortion of the tufts as the elongated pile sub-assembly 100 passes through the guide slot 106. The guide slope 106 exits the lay-in ring tangentially and at an angle less than perpendicular to the axis of rotation of the mandrel 110. The exit angle 112 is preferably not less than 45 degrees and preferably more than 80 degrees and most preferably 85 degrees which works well for several elongated pile sub-assembly beam combinations. The stiffer the base member 117 (e.g. beam) of the elongated pile sub-assembly 100 the more perpendicular the entrance angle 112 must be, so as to transition onto the helix 160 without detrimentally (i.e. disturbing adjacent abutment of the wraps with each other and interrupting contact of the bottom surface of the wrap with the mandrel surface) disturbing the wraps 107. Conversely, the more flexible the beam of the elongated pile sub-assembly, the less critical is the selection of the approach angle.

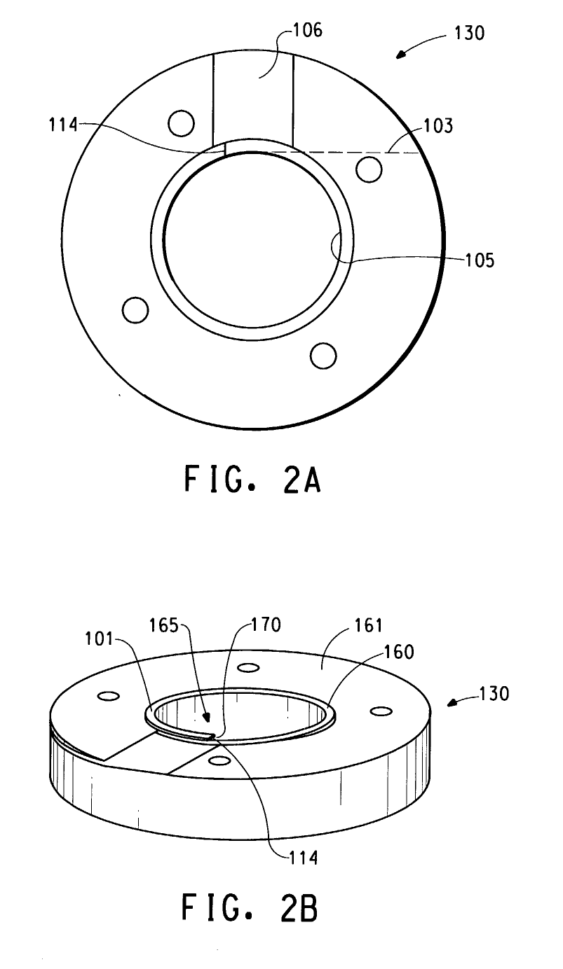

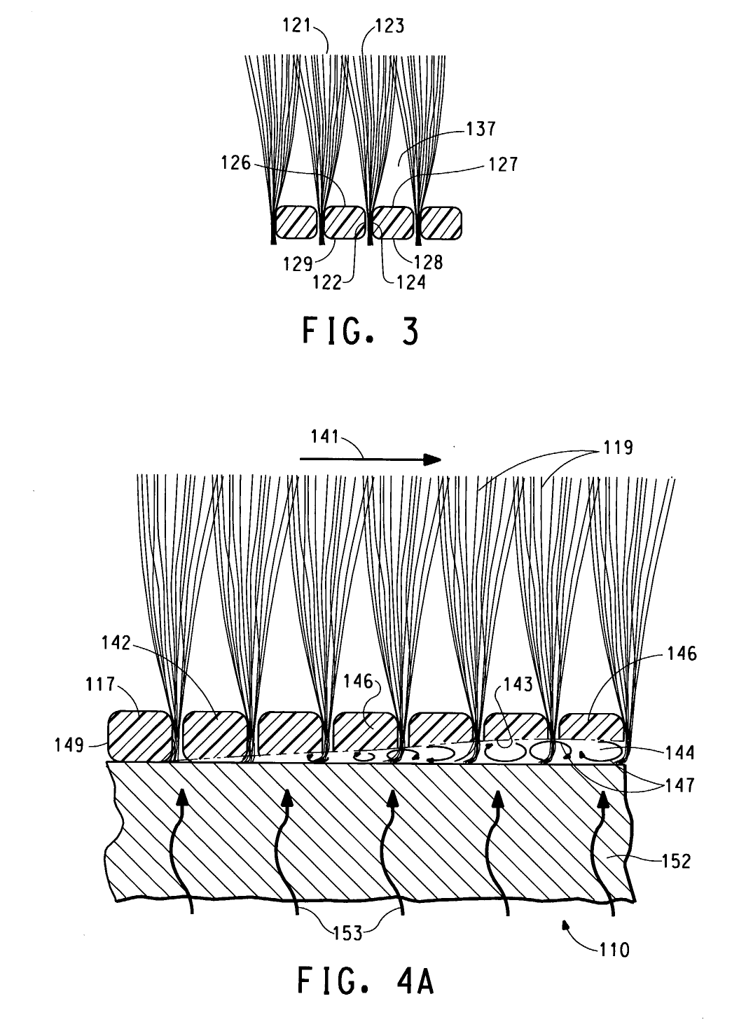

Referring now to FIG. 2A, the guide slot 106 is further described as being a groove having bottom 103 that is tangent to the inner diameter 105 of the lay-in ring 130. While the twelve o'clock tangential position of guide slot 106 is shown in FIG. 2A, other tangential locations of the groove or slot having a bottom 103 are also suitable. The slot bottom 103 should be configured such that it intersects tangentially with the inner diameter 105 to avoid dispensing of the basal portion 120 of the elongated pile sub-assembly tuftstring such that it is displaced from the mandrel surface 104 (FIG. 1) at the exit 114 of slot 106.

A bearing (not shown) or other suitable friction-reducing device can be incorporated into the lay-in ring 130 to provide support for the mandrel and yet allow the lay-in ring to be stationary. The lay-in ring 130 is held in position by a suitable mechanism, such as fasteners, to a support assembly (not shown) to prevent the lay-in ring 130 from rotating and to positionally fix it axially about the mandrel 110. As the incoming elongated pile sub-assembly is dispensed (e.g. laid) onto the mandrel's surface 104 by the lay-in ring 130, tension is provided to ensure adequate pressure is exerted by the basal area 120 of the elongated pile sub-assembly against the mandrel surface 104 to prevent the occurrence of radial movement downstream in the core-forming process.

Referring now to FIG. 1B, which shows a cross-sectional view of the elongated pile sub-assembly of FIG. 1. In the present invention, as each wrap of the elongated pile sub-assembly is formed, the wrap, being created positionally, replaces and thus, displaces the preceding wrap. The replacement and displacement positioning is such that there are no gaps between adjacent wraps at the contacting areas 113a and 113b.

Reference is now made to FIG. 2B, which shows the lay-in ring 130 that dispenses the elongated pile sub-assembly through opening 170 and, against the face 101 of helix 160 and onto the mandrel located in a center aperture 165 of the lay-in ring 130. The helix 160 has a pitch of one (1) and is equal to the cross-sectional width 118 (FIG. 1B) of the elongated pile sub-assembly as measured through the beam and dense portion of the yarn (for a rooted tuftstring). The helix 160 is machined through the entire 360-degree face of the lay-in ring 130. A “faster” pitch may cause a non-uniform displacing force against the wraps 107 that can cause the wrapped elongated pile sub-assembly to disruptively bind against the mandrel. It is this displacing force generated by the helix 160 that presses the elongated pile sub-assembly into intimate contact with adjacent wraps of elongated pile sub-assemblies and causes the accumulation of the elongated pile sub-assembly wraps to translate one elongated pile sub-assembly width 118 along the mandrel 110 with each successive wrap.

As previously mentioned a plurality of elongated pile sub-assemblies can be fed through a guide slot. When such a plurality of elongated pile sub-assemblies are dispensed onto a mandrel, it is preferable to feed each individual elongated pile sub-assembly through an equally spaced dedicated guide slot 106 (i.e. only one elongated pile assembly is fed into each slot). The pitch of the helix 160 would then be a multiple of the number of elongated pile sub-assemblies being fed onto the mandrel. For example, when two elongated pile sub-assemblies, one red and one white, are fed onto the mandrel by the guide slots, it is preferred to feed one (e.g. red) at the twelve (12) o'clock position and the other (e.g. white) at the six (6) o'clock position. The pitch of the helix will be two (2) over the 360-degree face of the lay-in ring 130.

With continuing reference to FIG. 2B, the flange face 161 of lay-in ring 130 is recessed from the helix face 101. The function of the recess is to reduce contact of the tufts with the flange face 161, thus providing a less restrictive space to allow the tufts to return to a more relaxed position after having passed through guide slot 106 and before being adjacently compressed along the contact areas 113a and 113b (FIG. 1B) of the sequentially wrapped elongated pile sub-assembly. The guide slot 106 can be confining or binding, especially to bulky yarns, causing them to lay back opposite to the direction of movement of the elongated pile sub-assembly. Preferably, the tufts relax back to a more normal, radial orientation before entering the heat zone (melt forming section) 140 (FIG. 1A) where this “lean” could take on a permanent set. The recessed distance between the helix face 101 and the lay-in ring flange face 161 is determined according to the bulk of the tuft yarns and the width of the beam 117. Generally, a recessed (e.g. relief) distance of about 0.100 inch has been found to work well. There may be other similar mechanisms for dispensing the elongated pile sub-assembly for use in the present invention.

Referring again to FIG. 1A, each elongated pile sub-assembly wrap 107 is in complete contact with another adjacent elongated pile sub-assembly wrap 107 at the contacting surfaces 113a and 113b (FIG. 1B). More specifically as shown in FIG. 3, the elongated pile sub-assemblies 121, 123 are aligned such that the vertical beam surface 122 of elongated pile sub-assembly 121 is adjacent to and in contact with the fibrous yarn bonded to the beam face 124 of elongated pile sub-assembly 123. There is also alignment of the top and bottom sides 126, 127 and 128, 129 of the beams, respectively. It is critical that this alignment be achieved and held through the melt forming section 140 so that misalignment does not occur. Such misalignment can result in the beams contacting the mandrel in such a manner that uneven melting and poor bonding of the beams occurs. The elongated pile sub-assembly wraps 107, of the present invention, remain in constant contact with each other along the contact areas 113a, 11b and sufficient compressive pressure is maintained to keep the contacting surfaces 113a, 113b from shifting relative to one another. The compressive force is a function of the interfacial friction or braking force generated between the elongated pile sub-assembly wraps 107 and the mandrel surface 104 as the elongated pile sub-assembly wraps 107 translate along the mandrel 110. The interfacial friction is influenced by many variables, including wrap tension, composition of the elongated pile sub-assembly, mandrel surface conditions and material, and the presence (or lack thereof) of any lubrication substance.

With continuing reference to FIG. 1A, in the present invention, the elongated pile sub-assembly wraps 107 translate to and are passed over a source of thermal energy through the melt forming section 140 of the mandrel 110. The thermal energy source is sufficient to partially melt the inner radial portion of the beam 117, the yarn filaments or both and cause the polymer melt to flow and mix with the melt of an adjacent elongated pile sub-assembly wrap 107. The flow of thermal energy longitudinally out of the melt forming section 140 and to adjacent sections of the mandrel 110 may be reduced with the use of insulating partitions 145 on both axial ends of the melt forming section 140. Thermal energy sources known in the art may be utilized in the present invention. For example, electric heaters are a simple and effective thermal energy source. Another thermal energy source for the melt forming section 140 is hot oil. To maintain the desired temperature of the mandrel sections 150 and 180 at moderate or lower levels, a cooling medium such as water may be used. Electric power for heating and the flow of cooling water may be provided through slip rings and rotary unions at mandrel end 135 shown in FIG. 1A.

For most beams, especially those made from thermoplastic monofilament materials, shrinkage will occur as, they are heated. The processing of thermoplastic polymers into monofilaments typically has at least one draw processing step where the diameter is drawn smaller as the monofilament is stretched. Conditioning of the monofilament will reduce the rate of shrinkage but not eliminate it. With conditioning of the monofilament, shrinkage may occur in the elongated (longitudinal) direction and the monofilament thus, becomes shorter in length. As this shrinkage occurs in the melt forming section 140 a suitable taper is provided to accommodate the shrinkage.

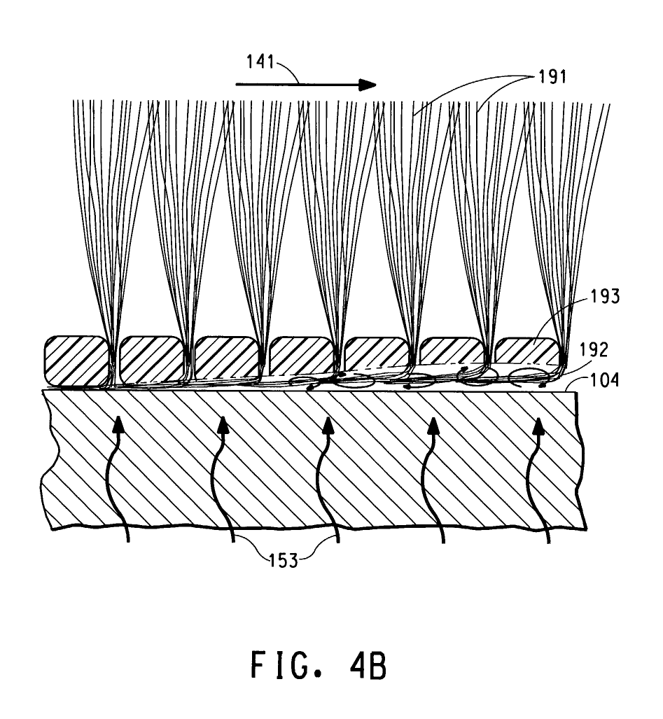

In FIG. 1A, the melt forming section 140 is comprised of two shorter sections 151 and 152. Where beam shrinkage during heating is a factor, section 151 is tapered to a smaller diameter in the direction of the translating wraps. The total taper is determined according to the material selected for the beam and its shrinkage rate. For example, a beam of nylon 6 material may shrink up to 18% when heated to 175° C., while a beam of polypropylene material may shrink up to 2% at 100° C. The rate of taper is determined by the rate or speed that the elongated pile sub-assembly wraps 107 translate along the mandrel 110. Once, the beam shrinkage has occurred, further tapering of the melt forming section 140 is no longer advantageous. Section 152 is a constant diameter over its length and continues the heating/melting of the inner radial section of the elongated pile sub-assembly as shown in FIG. 4A.

In order for the elongated pile sub-assembly to translate the entire length of the mandrel 110, it is important to avoid excessively heating and in particular, to avoid excessive melting of the beam 117 in the melt forming section 140. With continuing reference to FIG. 4A, an adequate “solid” outer radial portion 146 of the beam 117 must be retained while the inner radial portion 143 is allowed to melt. The solid outer portion 146 sustains the directional “push” shown by arrow 141 that translates the wraps 107 (FIG. 1A) away from the lay-in ring and is generated by the helix 160 of the lay-in ring 130 (FIG. 2B). The solid portion 146 also contains and prevents the polymer melt 144 from being displaced into the pile yarn 119. The balance between having an adequate melt 144 and good mechanical integrity of the non-melted portion of the beam 146 is controlled by the rate at which the wraps 107 translate, and the surface temperature of the melt forming section 140. Since thermoplastics are generally poor thermal conductors, a fast translating rate combined with a high surface temperature is preferred.

The polymer melt flows and mixes between the elongated pile sub-assembly as they translate across melt forming section 140. The translating solid portion 146 of the beam and the stationary (with respect to the wraps 107) mandrel causes the melt to flow and mix as indicated by the circular arrows 147. A boundary layer of melt in contact with the heated mandrel surface (represented by arrows 153) experiences some shear mixing as the solid non-melted portion 146 of the beam and the pile yarn 119 continue at a constant velocity across heating section 140 (FIG. 1A). The incoming and yet non-melted wrap 149 serves as a melt seal and pump to keep the melt moving at a rate equal to the translating elongated pile sub-assembly. Since the upper radial portion of the beam and dense fiber bundle remain solid and float on the melt, the displacing force that translates the wraps 107 along the mandrel 110 are retained through the melting process.

Referring again to FIG. 1A, the source of thermal energy is removed beyond melt forming section 140, therefore the polymer melt begins to loose heat to the surroundings and in particular, to mandrel section 180. As the thermal energy is removed from the layer of melt, the polymer melt cools to a solid again thus forming a continuous tube core with the elongated pile sub-assembly anchored in and/or bonded to the tube and to each other.

As the heated elongated pile sub-assembly and the fluid layer of melt cool, a shrinkage force against the mandrel may be generated again. To accommodate this shrinkage, the mandrel diameter may be tapered through cooling section 180 (FIG. 1A) to prevent binding of the newly formed tube on the mandrel 110. The diameter of the mandrel at the end of the taper in section 180 would be slightly undersized from the final inside diameter of the now continuous core of the present invention. The undersized diameter significantly minimizes any additional drag of the tube against the mandrel 110.

The rooted tuftstring as described in co-pending and concurrently filed application DuPont Docket No. AD6827, (U.S. Provisional Patent Application No. 60/336,226) is of particular benefit in the present invention. With reference to FIG. 4B, the short segment fibers or roots 192 trail behind the elongated pile sub-assembly as it translates along the mandrel surface 104. In a rooted tuftstring made with a polypropylene beam and nylon yarn filaments, the beam, being made of polypropylene, will melt well below the melt temperature of the nylon fibers, thus, retaining much of the nylon fiber properties. This is a desirable rooted tuftstring material combination. The short segment fiber roots 192, lying under and behind the partially melted beam 193 to which they are attached, become positioned under the adjacent, advancing, upstream wrap 191. The effective length of the roots 192 is increased as the bottom portion of the beam is melted thus extending the reach of the fiber roots. The fiber roots from each elongated pile sub-assembly thus, overlap with and intermingle with the next successive wrap, such that upon cooling a fiber reinforced, fused polymer joint is formed between the two adjacent wraps.

With reference again to FIG. 1A, after the mandrel section 180 is an accumulation section 185 and the termination end 200 of the mandrel 110. A slitter knife (not shown) or any other cutting mechanism known in the art is positioned slightly beyond the termination end and is timed to engage with the continuous pile covered tube so as to cut the continuous tube into segments of a predetermined length. Other operations may be performed on the pile covered tube before packaging it as a paint roller, such as beveling the ends. One particular advantage of the method of the present invention in forming pile covered rolls is that the pile height is very uniform thus trimming of the pile to even up the pile height is not needed. This eliminates a processing step and eliminates the disposal of fiber waste that occur in other methods.

Alternatively, the continuous pile covered tube can be slit spirally along the length of the continuous pile covered tube and then flattened forming a flat pile assembly such as a flooring article. This spiral cutting being performed most preferably prior to removing the tube from the mandrel and soon after passing the mandrel heat zone section so as to eliminate the need to reheat and remove the spiral set that would otherwise be present. The beam material selection and thickness are factors to consider in forming a flat pile assembly in the present invention.

The physical size of mandrel 110 is determined according to the material properties. The diameters of each mandrel section is selected according to the properties of the material used for the beam 117 and the final internal diameter required of the completed pile covered tube. Sections 150, 140, 180 and 185 are shown in FIG. 1A, as being approximately equal in length, however, they need not be of equivalent length.

The melt forming section 140 and cooling section 180 may be covered with a non-stick, high temperature material, such as DuPont Teflon™ or Kapton™ as a lubricant. This reduces the potential for polymer melt to stick, degrade and disturb the translating elongated pile sub-assembly wraps.

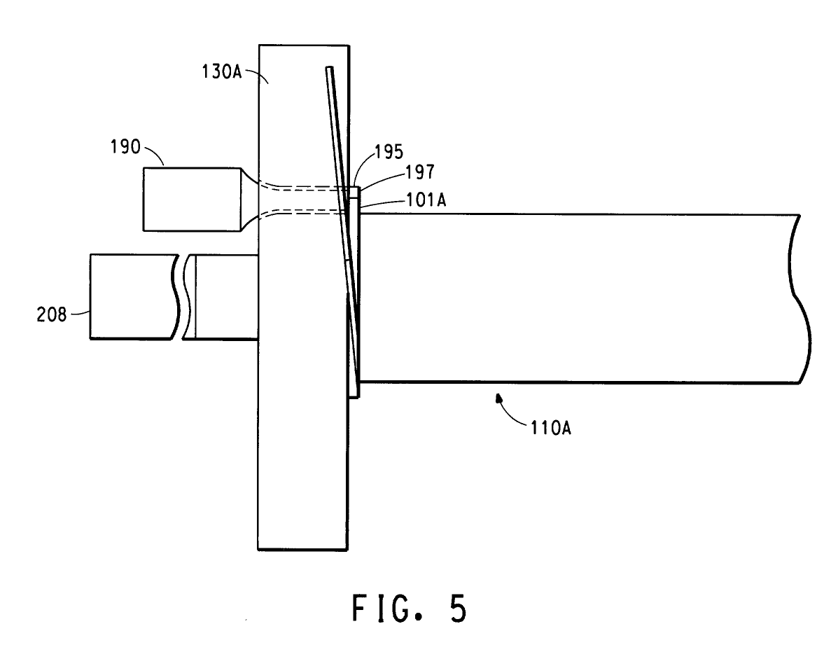

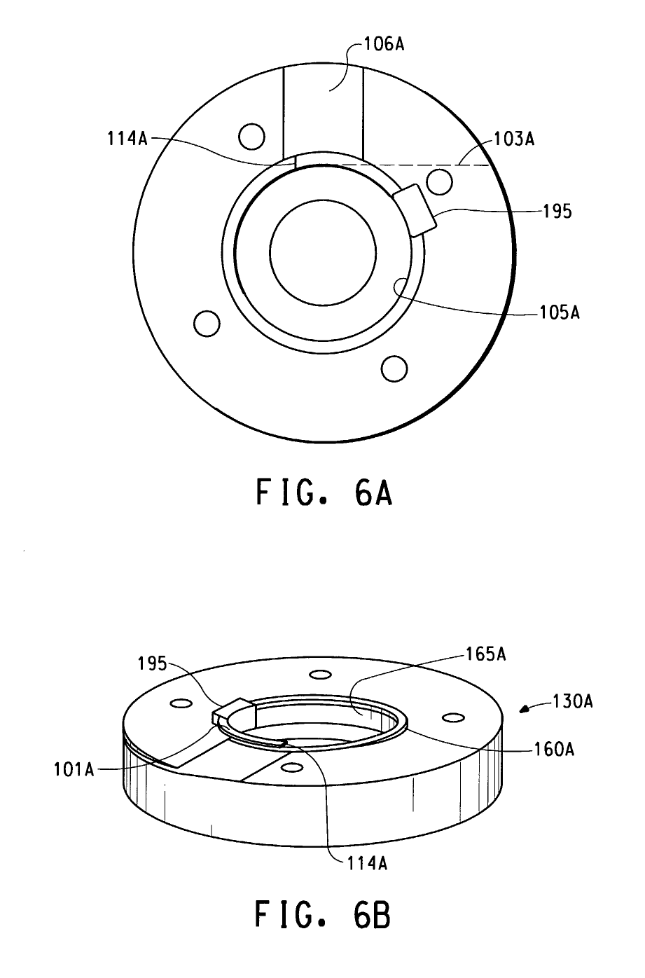

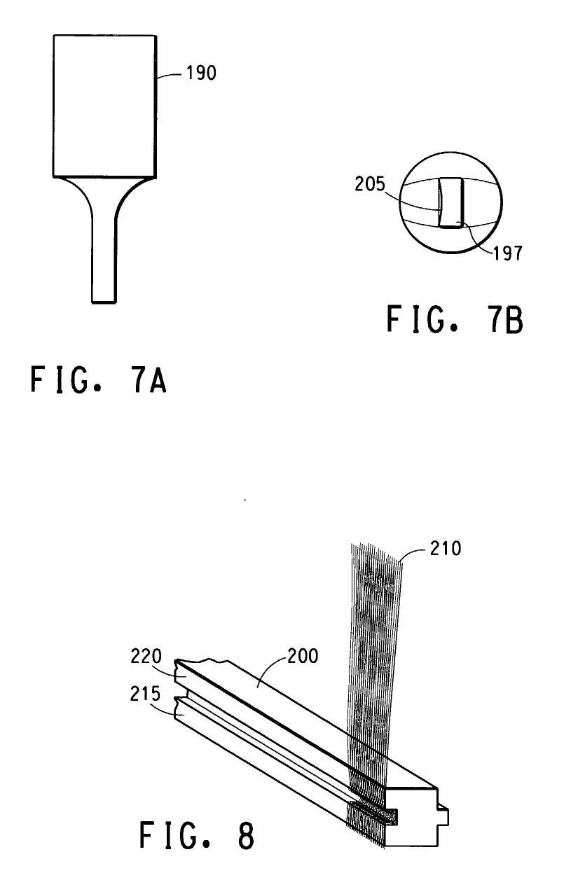

Another embodiment of the present invention is shown in FIGS. 5, 6A, 6B, 7A and 7B. FIG. 5 schematically shows an alternate apparatus embodiment of the present invention for forming a continuous pile covered tube from one or more continuous elongated pile sub-assemblies. In this embodiment, the process uses an ultrasonic horn 190 of an ultrasonic assembly (not shown) as the source of energy for melting and fusing the vertical surfaces 122, 124 of the wraps 107 together. Referring now to FIGS. 6A, 6B, 7A and 7B, the horn tip 195 is located within the lay-in ring 130A such that the plane which defines the horn face 197 is coplanar with the face 101A of helix 160A and the inside edge 205 (FIG. 7B) of the horn tip is tangent to the inside diameter 105A of the lay-in ring. When a single elongated pile sub-assembly 100 is fed into this apparatus, the ultrasonic assembly is located at a preferred position of at least 250-degrees from the guide exit 114A (FIG. 6A) in the direction of rotation of the mandrel, but no more than 290-degrees. At least 250-degrees is needed to ensure that adequate tensioning and compaction of the to-be-bonded wrap (i.e. pre-bonded wrap) has occurred with the previously bonded wrap. A position greater than 290-degrees is not as preferable due to interference with the path of the elongated pile sub-assembly through guide slot 106A.

As the to-be-bonded wrap comes into contact with the energized horn face 197 (FIG. 7B), mechanical energy is transferred from the horn 190 to the to-be-bonded wrap causing it to vibrate. The previous wraps having been fused to one another form a large mass that essentially is not “vibrating”. The vibrating vertical surface of the to-be-bonded wrap is in contact with the vertical surface of the previous wrap which is not vibrating. Frictional heat is generated at this interface (between the vertical surface of one beam side not having bundles attached to it and the opposite vertical surface of the other beam having a dense portion of yarn bonded to it) and causes at least one and preferably both surfaces to melt. When the energy is removed, as happens when a given segment of the continuous wrap is rotated past the face of the horn, the melt immediately freezes (e.g. cools to a solid) and fuses the two surfaces together.

A preferred geometric shape of the horn tip 195 is shown in FIGS. 6A, 6B, 7A and 7B. Side 205 (FIG. 7B) of the horn tip 195 is curved with the curvature having a radius equal to that of surface 105A of the lay-in ring 130A. A curved surface extends the area of the horn face 197 (FIG. 7B) that will be in contact with the beam portion of the wrap and thus increases the weld time that the horn is able to transfer energy to the wraps. A rectangular faced horn, by contrast, has only a fixed area of contact with a wrap's beam portion regardless of how large the horn face is made. The ability to customize the contact area of the curved horn provides another variable (e.g. other variables include power setting and bonding force) to control the process of ultrasonically fusing the wraps together.

When ultrasonic energy is used for the fusing of wraps to one another, the driven end 208 (FIG. 5) of the mandrel must be reduced in diameter so as to not interfere with the complete ultrasonic horn assembly (not shown). The mandrel 110A of this embodiment is less complex than that of the previously discussed embodiment. Since there is no significant heating of the beam of the elongated pile sub-assembly wrap, there is no shrinkage to design for and therefore no tapered sections. Furthermore, the ultrasonic assembly provides just enough energy to fuse the contacting vertical surfaces together, thus, eliminating the need for a heat removal (cooling) system. The shortened total length of the mandrel becomes an accumulating section similar to the one described earlier in FIG. 1A with one exception. The ultrasonic process requires the fused wraps to avoid efficient vibration, thus the shortened mandrel should not be reduced in diameter as a means of drag reduction for the wraps translating over it. The shortened length of the mandrel 110A manages total drag.

Another embodiment of the apparatus of the present invention includes feeding a polymer melt from a circular die incorporated into the surface of the mandrel. This extrudate bonds with and fuses together the elongated pile sub-assembly wraps and forms a core as it cools and solidifies. Section 140 of FIG. 1A could be replaced with such a die assembly and section 180 would provide the cooling as discussed above.

Once a pile covered core from one of the above inventions has been formed, the continuous pile covered core may be slit or cut into sections of predetermined length for use for example as paintbrush rollers. The inside diameter (ID) of a commercially available paintbrush rollers is nominally 1.5 inches. To provide rollers of this inside diameter using the core-forming elongated pile sub-assembly methods of the present invention discussed above, a cylindrical mandrel is used. Referring again to FIG. 1A, the mandrel is slightly oversized in section 150 and has tapered sections 151 and 180 to accommodate shrinkage of the wraps in the heating and cooling cycles, an accumulation section 185 and a discharge end 200. The diameter of section 150, which establishes the starting diameter of the wraps 107, is sized according to the total shrinkage of the wraps through each processing section and the desired diameter of the final product.

The core thickness used routinely in standard size paint rollers (1.5″ I.D.×9″ long) is generally and most preferably between about 0.050 and about 0.065 inches. However, the core thickness can range between about 0.020 and 0.200 inches and preferably between 0.020 inches and 0.100 inch. Referring to FIG. 1B, the beam 117 of the elongated pile sub-assembly forms the supporting core structure as described above. Using this method of paint roller production, the beam may have a height dimension of between about 0.020 inches to 0.200 inches. Preferably the beam should have a height dimension (h) of between 0.020 and 0.100 inches and most preferably between about 0.050 and about 0.065 inches. However, a height (h) of greater than 0.020 inches is satisfactory. The material selection for the elongated pile sub-assembly beam and the desired strength of the core to resist crushing are the primary factors for selecting the height (h) of the beam. Thicker beams will produce pile covered cores with greater resistance to crushing, while thinner beams will yield rollers (e.g. pile covered cores) having a surface capable of reduced resistance to crushing but will conform better to non-planar surfaces. The width (w) dimension of the beam, shown in FIG. 1B, for forming cores for pile coverage, is selected by at least two factors: 1) the desired tuft or pile density (although this is only one means of controlling pile density), and 2) the paint holding capacity.

Increasing the elongated pile sub-assembly beam cross-section, spaces the helical arrays of tufts further apart, thus decreasing tuft density per unit area of surface. An alternative is to wrap, alternately, a beam having no yarn attached to it as a spacer. The ability for a roller to hold and release paint can be optimized for a given pile height and tuftstring tufts per inch by utilizing the space between rows of tufts and the “canopy” of yarn fibers as a reservoir (see 137 of FIG. 3) for the paint. Larger base strings would space out the tufts further creating a larger cavity for paint collection.

Elongated pile sub-assemblies with beams having a generally rectangular cross-section are preferred. Along the beam length, one of the two vertical surfaces of a rectangular beam, has yarn segments attached thereto. Each vertical surface will be paired with the opposite vertical side surface of an adjacent elongated pile sub-assembly beam. With both vertical, contacting surfaces of each beam pair being flat and parallel to the helix face 101, the displacing force generated by the helix 160 is entirely parallel to the mandrel surface and centered on the helix face 101. More importantly, there is no lifting force generated as the surfaces are pressed against each other by helix 160, as is the case when flat, non-parallel surfaces to the helix face 101 are used. A lifting force could be disruptive to the longitudinal displacement of the wraps causing the formation of irregular shaped cores or both. To assist with alignment of the beam sides, the surface plane of the bottom of the beam is perpendicular to the two sides. The top portion of a beam's cross-section does not influence the beam alignment and can have one or more straight or curved surfaces. A beam having a single top surface, parallel to the bottom surface, and perpendicular to the vertical sides, would be particularly easy to manufacture and the symmetry would allow greater flexibility in processing the beam to form an elongated pile sub-assembly. Other geometric cross-sectional beam shapes, such as hexagons, and octagons meet the criteria of having vertical sides and a bottom that is perpendicular to the vertical sides may be applicable, but are less stable because of the shorter distance across the flats. Other beam cross-sectional shapes that are oval or circular can be used, but vertical displacement as described above is more difficult to control.

Another embodiment of the present invention is to utilize beams with interlocking shapes such as 200 (FIG. 8). The interlocking feature connects the beams 200 to one another and the tufts 210 can be attached along the beams vertical surface either just along the bottom non-recessed vertical region 215 which is preferred, the top vertical non-recessed vertical region 220 or both non-recessed regions prior to the interlocking feature connection. However, it is very difficult to preserve the interlocking feature while fabricating the elongated pile sub-assembly.

Another requirement of the geometric shape of the vertical contacting interface of the elongated pile sub-assembly beam is that it provides a seal to contain the polymer melt between the non-melted portion of the beam and the mandrel surface. Flat surfaces, having more contact area than rounded surfaces are better suited for this function as well.

The preferred polymer for the core structure of a paint roller is polypropylene. Polypropylene is chemically resistant to many solvents found in paint and other surface-treating fluids, such as stains and preservatives. Other materials selected from the groups consisting of aliphatic polyamides, aromatic polyamides, polyester, polyolefins, styrenes, polyvinylchloride (PVC), fluoropolymers, polyurethane, polyvinylidene chloride, polystyrene and styrene copolymers and copolymer mixes may be used. The elongated pile sub-assembly beam of the present invention is the single largest component of this core-forming technology and thus, is preferably one of the above listed materials. More preferably, the base string is a monofilament made of polypropylene.

When a beam without yarn attached to it is used as a spacer between the elongated pile sub-assembly wraps, the material of the beam may be selected from the group of materials identified above or from additional groups of materials for their adhesive properties.

The elongated pile sub-assemblies of this invention preferably are comprised of yarn fiber(s) that melt at a temperature significantly higher (e.g. greater than 30 degrees Celsius) than the beam. The elongated pile sub-assembly of this invention are more preferably comprised of a beam material of polypropylene and the tufts of nylon yarns or polyester yarns or both. Most preferably, the elongated pile sub-assembly used in the present invention are rooted tuftstrings as described in co-pending and concurrently filed application DuPont Docket No. AD6827, (U.S. Provisional Patent Application No. 60/336,226) comprised of a beam material of polypropylene and the tufts of nylon yarns or polyester yarns or both. In the present invention, when the beam preferably melts, the short segment fiber retains much of its physical properties at the processing temperatures, and the short segment fibers are long enough to extend under an adjacent beam to which the fibers are not attached, a fiber reinforced bond is formed upon cooling of the polymer melt.

In the present invention, the manufacturing process for rollers, such as paint roller brushes, has greater efficiency using thermoplastic polymers as beams that can be re-melted and fused together with another compatible material or element. This process eliminates several processing steps (especially the making of a pre-formed fabric strip) and greatly reduces the need for many raw materials (e.g. adhesives, fabric backing and core bodies) found in conventional methods of manufacturing paint rollers, flooring articles and other pile assembly articles thereby resulting in further savings by reducing raw ingredient costs and inventory requirements.

It is therefore, apparent that there has been provided in accordance with the present invention, articles, a method and apparatus of making elongated pile sub-assembly articles and products without preformed cores or additional materials such as adhesives that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A method to form a pile assembly comprising:
guiding at least one elongated pile sub-assembly onto a mandrel having a surface, the at least one elongated pile sub-assembly comprising a base member with at least one tuft extending therefrom;
wrapping said base member of the at least one elongated pile sub-assembly around the surface of the mandrel forming a plurality of abutting wraps of said base member about the mandrel surface and concurrently said base member having a surface between the abutting wraps directly contacting the mandrel surface;
heating the abutting wraps of said base member forming an at least partial melt of said base member of an at least alternate wraps, the at least partial melt creating a bridge between the abutting beam wraps;
cooling a melt bridge of the at least partial melt of the abutting wraps to form a fused joint between abutting beams of the abutting wraps and further forming a continuous tubular base from which the at least one tuft of the elongated pile sub-assembly extends outwardly therefrom; and
cutting the continuous tubular base to form at least one pile covered segment.

2. A method according to claim 1, wherein the cutting step further comprises:
rotating the mandrel having the continuous tubular base thereon; and
cutting the rotating continuous tubular base spirally, along a bond line formed by the bond joint between the abutting beams creating the continuous tubular base, to form a flat pile covered segment.

3. A method according to claim 1, wherein the cutting step further comprises cutting the continuous tubular base pile into at least one tubular pile covered segment, the at least one tubular pile covered segment a length less then the continuous tubular base.

4. A method according to claim 1, wherein the base member comprises a beam and the at least one tuft having at least one bond joint between said beam and said tuft.

5. A method according to claim 4, wherein said beam is a thermoplastic polymer.

6. A method according to claim 5, wherein the thermoplastic polymer is made of material selected from the group consisting of aliphatic polyamides, aromatic polyamides, polyester, polyolefins, styrenes, polyvinylchloride (PVC), fluoropolymers, polyurethane, polyvinylidene chloride, polystyrene and styrene copolymers and copolymer mixes.

7. A method according to claim 5, wherein the thermoplastic polymer is polypropylene.

8. A method according to claim 4, wherein said tuft is an extension of at least one fiber bonded to said beam.

9. A method according to claim 8, wherein the at least one fiber is a plurality of yarn fibers.

10. A method according to claim 8, wherein the at least one fiber is a plurality of bristle monofilaments.

11. A method according to claim 1, wherein said mandrel is rotated to wrap the at least one elongated pile sub-assembly about said mandrel.

12. A method according to claim 1, wherein the guiding step comprises:
orienting the at least one elongated pile sub-assembly through a guide; and
discharging the base member of the at least one elongated pile sub-assembly from the guide onto the mandrel surface with the tuft projecting outwardly from the base member in contact with said mandrel.

13. A method according to claim 12, wherein the guiding step further comprises discharging, from the guide, the elongated pile sub-assembly at a tangential angle to said mandrel, the angle being defined as between normal and 45-degrees to the longitudinal axis of said mandrel.

14. A method according to claim 12, wherein the guiding step further comprises discharging from the guide the elongated pile sub-assembly at a tangential angle of 85-degrees from the longitudinal axis of said mandrel.

15. A method according to claim 11, wherein the guiding step further comprises using a guide having a helical wedge to displace the oriented elongated pile sub-assembly longitudinally on the surface of the rotating mandrel.

16. A method according to claim 15, wherein the helical wedge displaces the oriented elongated pile sub-assembly longitudinally on the mandrel surface a distance substantially equal to the width of the base member of the elongated pile sub-assembly.

17. A method according to claim 15, wherein the helical wedge is used to displace a series of abutted and sequentially wrapped elongated pile sub-assemblies longitudinally along the mandrel surface.

18. A method according to claim 1, wherein heating the abutting wraps to at least partially melt the base member comprises using a thermal energy source along a section of the mandrel.

19. A method according to claim 18, wherein the thermal energy source is sufficient to heat the surface of the mandrel section causing at least partial melting of the base member of the elongated pile sub-assembly in contact with the mandrel section surface.

20. A method according to claim 19, wherein the at least partial melting of the base member comprises melting at least one of a portion of a beam and a portion of the tuft bonded to the beam.

21. A method according to claim 19, wherein the at least partial melting of the base member comprises melting a portion of an inner radial section of the base member.

22. A method according to claim 21, wherein the at least partial melting of the base member further comprises retaining an outer radial section having adequate mechanical properties to transmit a force emanating from a guiding means to maintain a longitudinal movement of the wraps along a length of the mandrel.

23. A method according to claim 1, wherein the base member of alternating wraps is the base member of each wrap.

24. A method according to claim 1, wherein the melt bridge is formed by the flow of polymer melt from at least one wrap base member to an abutting wrap base member.

25. A method according to claim 1, wherein the fused joint, formed between abutting base members, is at least one of a mechanical and a chemical bond.

26. A method according to claim 1, wherein the cooling of the melt bridge occurs due to the exchange of thermal energy with a section of the mandrel surface.

27. A method according to claim 3, wherein the cutting of the continuous tubular base is synchronized with the advancing wraps producing pile covered tube segments of uniform length.

28. A method according to claim 27, wherein the tube segments are nine (9) inches in length.

29. A method according to claim 1, wherein the heating step comprises applying heat to the abutting wraps of the base member using an ultrasonic energy device.

30. A method according to claim 29, wherein the ultrasonic energy device comprises an ultrasonic horn assembly incorporated into a guide of the guiding step.

31. A method according to claim 30, wherein the base member having opposite vertical surfaces perpendicular to the mandrel surface, said abutting wrap of said base member being heated sufficiently along at least one of the abutting vertical surfaces of the base member to melt at least one of the abutting vertical surfaces forming a melt bridge between the abutting vertical surfaces.

32. A method to form a pile assembly comprising:
guiding at least one elongated pile sub-assembly onto a mandrel having a surface, said at least one elongated pile sub-assembly comprising a base member with at least one tuft extending therefrom;
wrapping the base member of the at least one elongated pile sub-assembly around the surface of said mandrel forming a plurality of adjacently abutting wraps of said base member about the mandrel surface, said base member having opposite vertical surfaces for abutting and concurrently having a surface, between the opposite vertical surfaces of the abutting wraps, directly contacting the mandrel surface;
indexing each of the abutting wraps forward to form a plurality of abutting base member wraps, such that each base member has a surface that concurrently adjacently abuts the mandrel surface and other surfaces is for adjacently abutting wraps;
providing a polymer melt from within said mandrel to a circumferential discharge slot;
forming a continuous tube from the polymer melt underlying the indexing base member wraps;
cooling the continuous tube of the polymer melt forming a fused connection between the base member wraps creating a continuous tubular base from which the tuft of the elongated pile sub-assembly extends outwardly therefrom; and
cutting the continuous tube to form at least one pile covered segment.

33. A method according to claim 32, wherein the cutting step further comprises rotating the mandrel having the continuous tubular base thereon; and cutting the rotating continuous tubular base spirally, along a bond line formed by the fused connection between the base member wraps forming the continuous tubular base, to form a flat pile covered segment.

34. A method according to claim 32, wherein the cutting step further comprises cutting the continuous tubular base creating at least one tubular pile covered segment of less length then the continuous tubular base.

35. A method according to claim 32, wherein the polymer melt is a thermoplastic material.

36. An apparatus for making pile assemblies comprising a:
means for guiding at least one elongated pile sub-assembly, having a base member and a tuft attached thereto, onto a mandrel having a surface;
means for wrapping the base member of the at least one elongated pile sub-assembly around the mandrel surface to form a plurality of abutting base member wraps, the base member of each wrap has a surface that concurrently abuts the mandrel surface and other surfaces that abut adjacent wraps shoulder to shoulder;
means for heating the base member wraps to at least partially melt the base member of at least alternating wraps;
means for bridging a melt between abutting base member wraps;
means for cooling a melt bridge of the abutting base member wraps to form a fused joint between abutting base members forming a continuous tubular base from which the tuft of the elongated pile sub-assembly extends outwardly therefrom; and
means for cutting the continuous tubular base to form at least one pile covered segment.

37. An apparatus according to claim 36, wherein the cutting means comprises a slitter, said slitter being used to cut spirally along a longitudinal axis of the continuous tubular base to form at least one flat pile covered segment.

38. An apparatus according to claim 37, wherein the at least one flat pile covered segment is a flooring article.

39. An apparatus according to claim 36, wherein the cutting means comprises a slitter, said slitter cutting the continuous tubular base into at least one tubular pile covered segment of less length then the continuous tubular base.

40. An apparatus according to claim 39, wherein the at least one tubular covered segment is a roller brush.

41. An apparatus according to claim 36, wherein the means for guiding at least one elongated pile sub-assembly having a base member and a tuft comprises a guide having:
an aperture through which the mandrel projects in directions opposite each other;
means for preventing the guide from rotating and moving axially relative to the mandrel; and
a groove for orienting and discharging the base member of the elongated pile sub-assembly onto the mandrel surface such that the tuft projects outwardly from the mandrel surface.

42. An apparatus according to claim 41, wherein said mandrel is rotatable.

43. An apparatus according to claim 42, wherein the aperture of the guide supports the rotatable mandrel.

44. An apparatus according to claim 42, wherein the groove discharges the elongated pile sub-assembly at a tangential angle to said mandrel, the angle being defined as between normal and 45-degrees to the longitudinal axis of said mandrel.

45. An apparatus according to claim 42, wherein the groove discharges the elongated pile sub-assembly at a tangential angle of 85 degrees from the longitudinal axis of said mandrel.

46. An apparatus according to claim 45, wherein the guiding means comprises means for indexing the elongated pile sub-assembly wrap longitudinally on the mandrel surface as said mandrel, being rotatable, rotates concentrically within a stationary helical wedge.

47. An apparatus according to claim 46, wherein the helical wedge displaces a plurality of abutting base members of helically wrapped elongated pile sub-assemblies longitudinally along the mandrel surface.

48. An apparatus according to claim 41, wherein said guide comprises a lay-in ring.

49. An apparatus according to claim 36, wherein the heating means of abutting base members comprises a thermal source within a section of the mandrel sufficient to heat the surface of the mandrel section and cause melting of at least a portion of the base member of the elongated pile sub-assembly in contact with the mandrel surface.

50. An apparatus according to claim 49, wherein the heating means is electric.

51. An apparatus according to claim 50, wherein the heating means is fluid heat transfer.

52. An apparatus according to claim 36, wherein the heating means of the base member of the wraps is sufficient to at least partially melt the base member of alternating wraps.

53. An apparatus according to claim 36, wherein the means for bridging the melt causes the polymer melt to flow from one abutting base member to the adjacent base member.

54. An apparatus according to claim 36, wherein the cooling means of the melt bridge to form a fused joint between the abutting base member wraps comprises a cooling fluid circulating through a section of the mandrel removing heat from the mandrel surface.

55. An apparatus according to claim 36, wherein the cutting means of the continuous tubular base comprises a slitter to cut the continuous tubular base into pile covered tube segments of a pre-determined length.

56. An apparatus according to claim 36, wherein the heating means for the base member wraps comprises an ultrasonic device.

57. An apparatus according to claim 56, wherein the ultrasonic device comprises an ultrasonic horn assembly incorporated into the guiding means.

58. An apparatus according to claim 36, wherein said mandrel has a cylindrical shape.

59. An apparatus for making pile assemblies comprising a:
means for guiding at least one elongated pile sub-assembly, having a base member and a tuft attached thereto, onto a mandrel;
means for wrapping the base member of the at least one elongated pile sub-assembly around the mandrel surface;
means for indexing each wrap forward to form a plurality of abutting base member wraps, such that each base member concurrently abuts the mandrel surface;
means to extrude a polymer melt from within the mandrel to a circumferential discharge slot;
means of forming a continuous tube of polymer melt underlying the indexing base member wraps;
means for cooling the continuous tube of melt to form a fused connection between the base member wraps and to form a continuous solid tubular base from which the tuft of the elongated pile sub-assembly extends outwardly therefrom; and
means for cutting the continuous tubular base to form at least one pile covered segments.

60. An apparatus according to claim 59, wherein the cutting means comprises a slitter, said slitter being used to cut spirally along the length of the continuous tubular base to form at least one flat pile covered segment.

61. An apparatus according to claim 60, wherein the at least one flat pile covered segment is a flooring article.

62. An apparatus according to claim 59, wherein the cutting means comprises a slitter, said slitter cutting the continuous tubular base into at least one tubular pile covered segment of less length then the continuous tubular base.

63. An apparatus according to claim 62, wherein the at least one tubular pile covered segment is a roller brush.

64. An apparatus according to claim 59, wherein the mandrel has a cylindrical shape.

65. An apparatus according to claim 59, wherein the polymer melt is a thermoplastic material.

66. A pile assembly comprising at least one elongated pile sub-assembly wrapped in a helical manner about a mandrel, each of the helical wraps being joined along a portion of an abutted vertical surface of an adjacent wrap, forming a continuous base material.

67. A pile assembly according to claim 66, wherein the at least one elongated pile sub-assembly comprises a beam and at least one tuft connected thereto.

68. A pile assembly according to claim 66, wherein the at least one elongated pile sub-assembly comprises a beam and plurality of tufts connected to the beam and extending radially therefrom.

69. A pile assembly according to claim 66, wherein the beam is a thermoplastic polymer.

70. A pile assembly according to claim 69, wherein the thermoplastic polymer is made of material selected from the groups consisting of aliphatic polyamides, aromatic polyamides, polyester, polyolefins, styrenes, polyvinylchloride (PVC), fluoropolymers, polyurethane, polyvinylidene chloride, polystyrene and styrene copolymers and copolymer mixes.

71. A pile assembly according to claim 69, wherein the thermoplastic polymer is polypropylene.

72. A pile assembly according to claim 67, wherein the tuft is at least one fiber.

73. A pile assembly according to claim 67, wherein the at least one fiber is a plurality of yarn fibers.

74. A pile assembly according to claim 67, wherein the at least one fiber is a plurality of bristle monofilaments.

75. A pile assembly according to claim 66, wherein said continuous base material encapsulates a basal portion of the elongated pile sub-assembly and at least one tuft extends outwardly away from said continuous base material.

76. A pile assembly of claim 75, wherein said elongated pile sub-assembly comprise a plurality of rooted tuftstrings having a root end for attaching to said continuous base material, and at least one tuft opposite the root end, forming the pile extending radially from the continuous base material.

77. A pile assembly of claim 76, wherein said continuous base material forms a cylindrical core.

78. A pile assembly of claim 77, wherein said cylindrical core is cut to a predetermined space length.

79. A pile assembly of claim 76, wherein the cylindrical core has a thickness between 0.020 inches and 0.200 inches.

80. A pile assembly of claim 79, wherein the cylindrical core has a thickness between 0.050 inches and 0.065 inches.

81. A pile assembly of claim 76, wherein said cylindrical core is a thermoplastic polymer.

82. A pile assembly of claim 76, wherein the cylindrical core comprises, aliphatic polyamides, aromatic polyamides, polyester, polyolefins, sytrenes, polyvinylchloride, fluoropolymers, polyurethane, polyvinylidene chloride, polystyrene and styrene copolymers and copolymer.

83. A pile assembly of claim 76, wherein the cylindrical core is polypropylene.

84. A pile assembly of claim 77, wherein said cylindrical core having at least one tuft extending radially therefrom forms a brush roller.

85. A pile assembly of claim 83, wherein said brush roller comprises an inner diameter of about 1.5 inches.

86. A pile assembly of claims 67-69, wherein the beam has a height of 0.020 inches to 0.200 inches.

87. A pile assembly of claim 86, wherein the beam has a height of approximately 0.050 inches to 0.065 inches.

88. A pile assembly of claim 76, wherein said continuous base material being flat with at least one tuft extending outwardly from said continuous base material forms a flooring article.

89. The apparatus of claim 48, wherein said lay-in ring provides sufficient pressure to keep the beam of the elongated pile sub-assembly in compression with the adjacent beam for fusing.

90. An elongated pile sub-assembly comprising:
a beam having an interlocking shape for connecting to at least one other beam; said beam having a first and second surface; at least one tuft being attached along a first surface of said beam such that the at least one tuft extends outwardly from said beam forming a pile.

91. An elongated pile sub-assembly of claim 90, wherein said interlocking shape comprises the beam having the first and second vertical surface opposite one another, separated by a thickness of said beam; the beam having an indentation on the first vertical side and a protrusion on the second vertical side, said indentation of the beam receiving the protrusion of the at least one other beam forming an interlocking pile assembly.
